(19) United States
(12) Patent Application Publication
(10) Pub. No.: US 2015/0145973 A1
(43) Pub. Date: May 28, 2015

(54) 3D IMAGE DISPLAY DEVICE AND 3D IMAGE DISPLAY SYSTEM WITH UNIFORM LUMINANCE

(71) Applicant: Shenzhen China Star Optoelectronics Technology Co., Ltd., Shenzhen City (CN)

(72) Inventor: Bin Fang, Shenzhen (CN)

(21) Appl. No.: 14/130,330

(22) PCT Filed: Nov. 27, 2013
(86) PCT No.: PCT/CN2013/087898

§ 371 Date: Dec. 31, 2013

(30) Foreign Application Priority Data
Nov. 22, 2013 (CN) 201310597805.4

(51) Int. Cl. H04N 13/04; G09G 3/36; G09G 3/34

(52) U.S. Cl. CPC H04N 13/0429; G09G 3/3406; G09G 3/3611
USPC 348/56

(57) ABSTRACT

The present invention discloses a 3D image display device including a backlight source driver providing N driving current signals, a backlight module including N backlight sources which emit lights when receiving N driving current signals in sequence, and a liquid crystal panel including a plurality of liquid crystal display zones. After the first frame images are displayed in the liquid crystal panel in the first time period when the second frame images are being displayed in the liquid crystal panel in the second time period, luminance of the 1^{st}˜k^{th} backlight sources is larger than luminance of the (k+1)^{th}˜N^{th} backlight sources because the backlight source driver adjusts N driving current signals. The 3D image display device raise luminance of corresponding backlight source at the beginning of every time-sequence, resulting in a high uniformity of luminance of the panel as a whole.

### BACKGROUND OF THE INVENTION

1. Field of the Invention

The present invention relates to a 3D image display device and 3D image display system, more particularly, to a 3D image display device and 3D image display system with uniform luminance.

2. Description of the Prior Art

Human beings see real-world images using both eyes. Further, the human brain forms so-called 3D images (three-dimensional images) according to differences in spatial distance between two views seen by both eyes from two different angles. A so-called 3D display is designed to create simulations of human visual fields from different angles to help users perceive 3D images when viewing 2D images.

Currently, 3D displays are divided into two kinds. One is auto-stereoscopic displays; the other is stereoscopic displays. Users of auto-stereoscopic displays are able to view 3D images without wearing glasses with a unique structure while ones of stereoscopic displays have to wear specially designed glasses to view 3D images.

FIG. 1 indicates operation of a display panel used in conventional stereoscopic tridimensional image display device. The display panel comprises a backlight module 12 and a liquid crystal panel 14. The backlight module 12 comprises a plurality of backlight sources 121-124. When an image is scanned, the plurality of backlight sources 121-124 of the backlight module 12 are turned on in sequence. The liquid crystal panel 14 provides left eye images and right eye images alternatively. If the current frame image is a left eye image, the next frame image is a right eye image. To prevent a user wearing a shutter glasses from viewing a previous left eye image when viewing a right eye image, the backlight sources 121-124 must be turned on in sequence. As in FIG. 1, after right eye images scanned from top to bottom and update for a while, deflection of liquid crystal molecules in upper part has finished, now the backlight source 121 must be turned on. The user can only view images on upper zone of the panel 14 through the glass (because the backlight sources 122-124 are still off). The backlight sources 122-124 will be turned on in sequence along with images update to make sure that less left eye images are viewed.

Refer to FIG. 2, FIG. 2 indicates time-varying changes of transmission of the shutter glasses. Generally, an enabling time period of the shutter glasses is 8.3 ms(=1/120 ms). If the backlight sources 121-124 are turned on in sequence, then the interval between turning on the backlight source 121 and turning off the backlight source 124 must be within the enabling time period of the shutter glasses. Rising response of liquid crystal molecules is generally 3 ms, which means it takes some time for liquid crystal molecules of the liquid crystal panel 14 to deflect to the required position, and resulting in moderate transmission of the shutter glasses at enabling time period. When the backlight source 121 turns on, the transmission of the shutter glasses is just moderate. Therefore, through the shutter glasses, luminance of the zone in the liquid crystal panel 14 corresponding to the backlight source 121 is relatively low, resulting in uneven luminance of the liquid crystal panel 14 as a whole.

### SUMMARY OF THE INVENTION

It is therefore a primary object of the present invention to provide a 3D image display device and a 3D image display system to solve the problem of uneven luminance in the prior art.

According to the present invention, a 3D image display device comprises a backlight source driver providing N driving current signals, a backlight module electrically connected to the backlight source driver, and a liquid crystal panel comprising a plurality of liquid crystal display zones to adjust alignment of liquid crystal molecules according to data signals. The backlight module comprises N backlight sources which emit lights when receiving N driving current signals in sequence, where N is a positive integral greater than 1. After the first frame image is displayed in the liquid crystal panel in the first time period, when the second frame image is being displayed in the liquid crystal panel in the second time period and the shutter glasses enables, luminance of 1^{st}˜k^{th} backlight sources is greater than luminance of (k+1)^{th}˜N^{th} backlight sources because the backlight source driver adjusts the N driving current signals, wherein N>k>1.

In one aspect of the present invention, magnitude of the 1^{st}˜k^{th} driving current signals is greater than magnitude on the (k+1)^{th}˜N^{th} driving current signals.

In another aspect of the present invention, a duty cycle of the 1^{st}˜k^{th} driving current signal is greater than a duty cycle of the (k+1)^{th}˜N^{th} driving current signal.

In yet another aspect of the present invention, the second time period of subsequent to the first time period.

In still another aspect of the present invention, the first frame image is a left eye image and the second frame image is a right eye image, or the first frame image is a right eye image and the second frame image is a left eye image.

According to the present invention, a 3D image display system comprises a shutter glasses with an enabling time period and a 3D image display device. The 3D image display device comprises a backlight source driver providing N driving current signals, a backlight module electrically connected to the backlight source driver, and a liquid crystal panel comprising a plurality of liquid crystal display zones to adjust alignment of liquid crystal molecules according to data signals. The backlight module comprises N backlight sources which emit lights when receiving N driving current signals in sequence, where N is a positive integral greater than 1. After the first frame image is displayed in the liquid crystal panel in the first time period, when the second frame image is being displayed in the liquid crystal panel in the second time period and the shutter glasses enables, luminance of 1^{st}˜k^{th} backlight sources is greater than luminance of (k+1)^{th}˜N^{th} backlight sources because the backlight source driver adjusts the N driving current signals, wherein N>k>1.

In one aspect of the present invention, magnitude of the 1^{st}˜^{th} driving current signals is greater than magnitude on the (k+1)^{th}˜N^{th} driving current signals.

In another aspect of the present invention, a duty cycle of the 1^{st}˜k^{th} driving current signal is greater than a duty cycle of the (k+1)^{th}˜N^{th} driving current signal.

In still another aspect of the present invention, the first frame image is a left eye image and the second frame image is a right eye image, or the first frame image is a right eye image and the second frame image is a left eye image.

In yet another aspect of the present invention, the enabling time period is longer than the first time period and the second time period.

In contrast to prior art, by adjusting magnitude and duty cycle of driving current signals, the 3D image display device and 3D image display system of the present invention enable every backlight source to generate lights of varying luminance according to driving current signals of varying magnitude and duty cycle, in order to raise display luminance of relatively dark zones of a liquid crystal panel, and eventually achieve an uniform luminance of the whole liquid crystal panel. More particularly, raising luminance of the liquid crystal panel when a shutter glasses are freshly turned on improves display quality of 3D image.

These and other objects of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 indicates operation of a display panel used in conventional stereoscopic tridimensional image display device.

FIG. 2 indicates time-varying changes of transmission of the shutter glasses.

FIG. 3 indicates a 3D image display system displaying tridimensional (3D) images.

FIG. 4 indicates a block diagram of a 3D image display device in FIG. 3.

FIG. 5 is a timing diagram of driving current signals from the backlight driver according to the first embodiment of the present invention.

FIG. 6 is a timing diagram of driving currents signals from the backlight driver according to the second embodiment of the present invention.

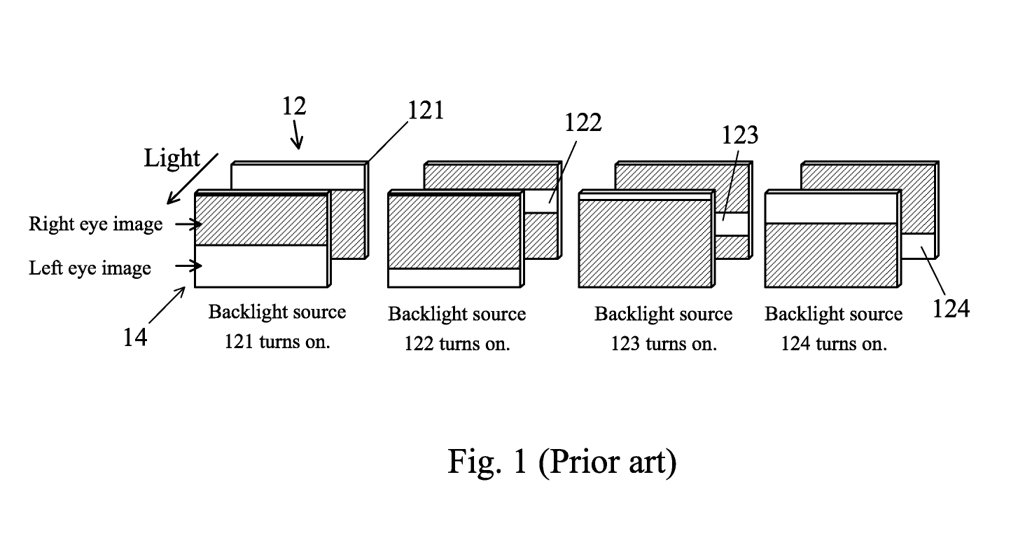

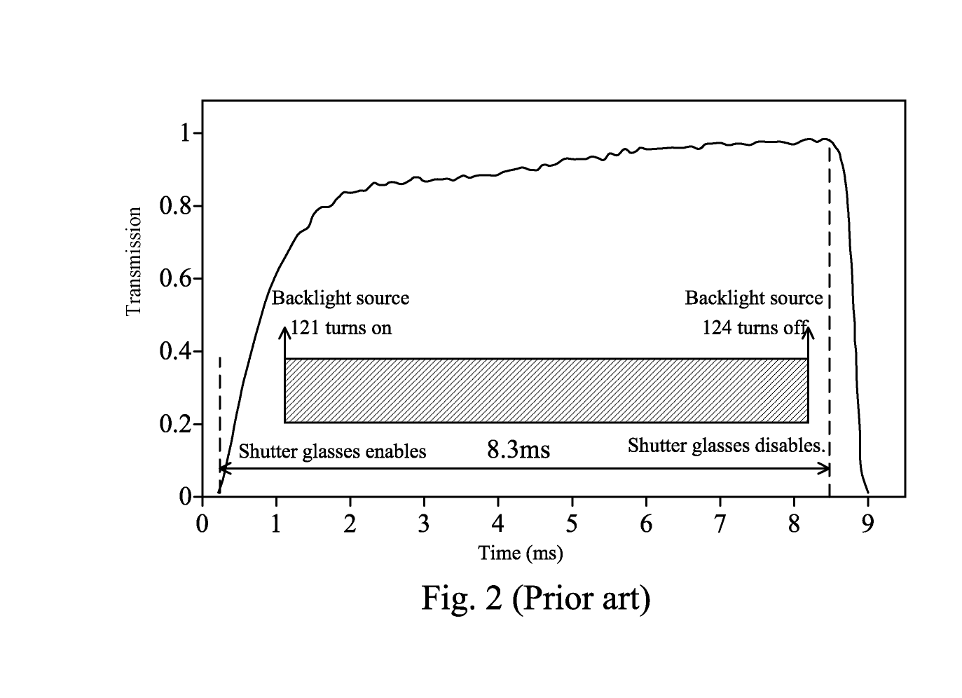

### DETAILED DESCRIPTION OF THE PREFERRED EMBODIMENT

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

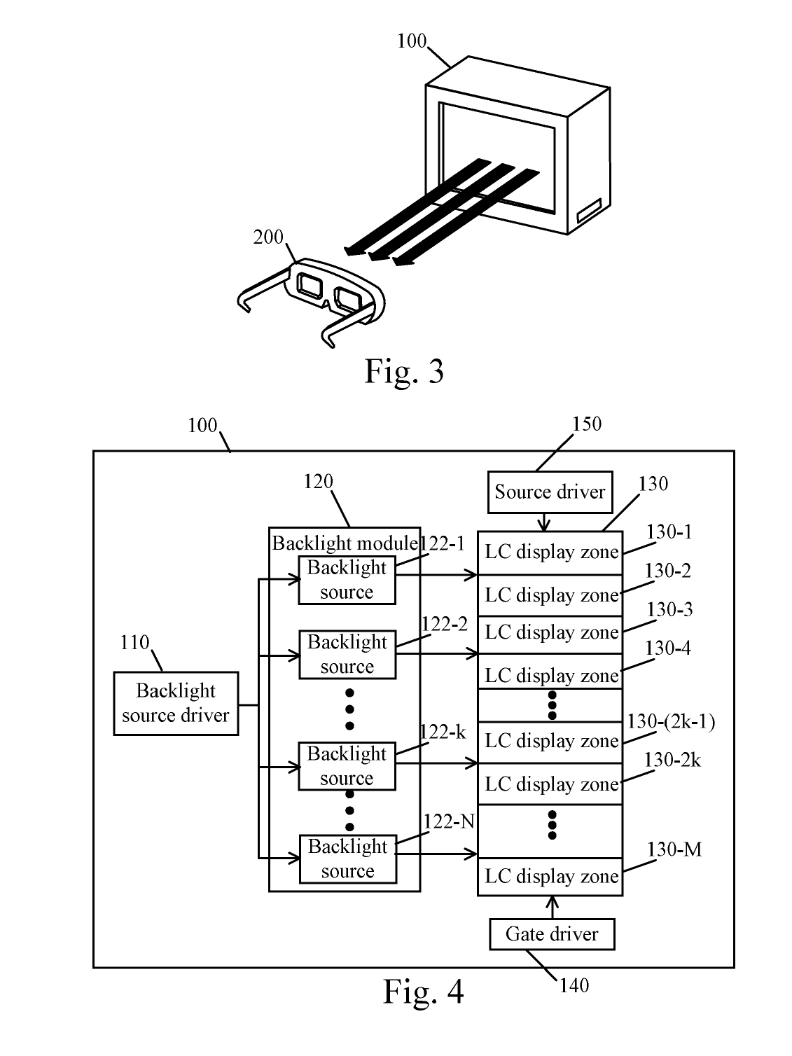

Please refer to FIG. 3 and FIG. 4. FIG. 3 indicates a 3D image display system displaying tridimensional (3D) images, FIG. 4 indicates a block diagram of a 3D image display device 100 in FIG. 3. The 3D image display system comprises a 3D image display device 100 and a pair of shutter glasses 200. Users perceive tridimensional images when they view left eye images and right eye images through the 3D image display device 100 alternatively by wearing the shutter glasses 200. The 3D image display device 100 comprises a backlight source driver 110, a backlight module 120, a liquid crystal panel 130, a gate driver 140 and a source driver 150. The backlight source driver 110 provides N driving current signals, whereas N is positive integral more than 1. The backlight module 120 comprising N backlight sources 122-1˜122-N is electrically connected to the backlight source driver 110, and N backlight sources 122-1˜122-N receive lights in sequence from the N driving current signals. Magnitudes and duty cycles of the N driving current signals impact luminance of lights from the backlight sources 122-1˜122-N. The backlight sources 122-1˜122-N can be light emitting diode (LED). The gate driver 140 generates scan signals, and the source drivers 150 generates data signals. The liquid crystal panel 130 comprises a plurality of liquid crystal display zones 130-1˜130-M. An alignment of liquid crystal molecules in the liquid crystal display zones 130-1˜130-M is adjusted according to the data signals when receiving the scan signals.

The shutter glasses 200 usually operates under a frequency of 60 Hz. In other words, it is turned on every 16.6 ms (1/60 ms) for duration of 8.3 ms (1/120 ms). In the embodiment, the duration of enabling time period is slightly longer than the display time periods of the first and the second frames.

For instance, the first frame is a left eye image and the second frame is a right eye image displayed in the liquid crystal panel 130 in the embodiment. Because the liquid crystal panel 130 generates left eye and right images alternatively, one having ordinary skill in the art is aware that the first frame could be a right eye image, likewise the second frame could be a left eye image. After the left eye image in the first frame are completely displayed in the liquid crystal display zones 130-1˜130-M, displaying the right eye image in the second frame begins in the liquid crystal display zone 130-1, meanwhile the previous left eye image remain in the liquid crystal display zones 130-2˜130M when a backlight source 122-N is turned on and emitting lights and backlight sources 122-1˜122-(N−1) are turned off and emitting no lights. Afterwards, the current right eye image in the second frame are displayed in the liquid crystal display zones 130-1 and 130-2, meanwhile the previous left eye image remain in the liquid crystal display zones 130-3˜130-M when the backlight source 122-N is turned on and emitting lights and backlight sources 122-1˜122-(N-1) are turned off and emitting no lights. Next right eye images in the second frame are displayed in the liquid crystal display zones 130-1˜130-3, meanwhile left eye images remain in the liquid crystal display zones 130-4˜130-M when the backlight source 122-1 is turned on and emitting lights and backlight sources 122-2˜122-N are turned off and emitting no lights, so that users can view right eye images displayed in the liquid crystal display zones 130-1˜130-3 but simultaneously be blind to the left eye images displayed in the liquid crystal display zones 130-4˜130-M. After that right eye images in the second frame are displayed in the liquid crystal display zones 130-1˜130-4, meanwhile left eye images remain in the liquid crystal display zones 130-5˜130-M, when the backlight source 122-1 is turned on and emitting lights and backlight sources 122-2˜122-N are turned off and emitting no lights, so that users can view right eye images displayed in the liquid crystal display zones 130-1˜130-4 but simultaneously be blind to the left eye images displayed in the liquid crystal display zones 130-5˜130-M. By these procedures, users would not view left and right eye images at the same time through the shutter glasses 200.

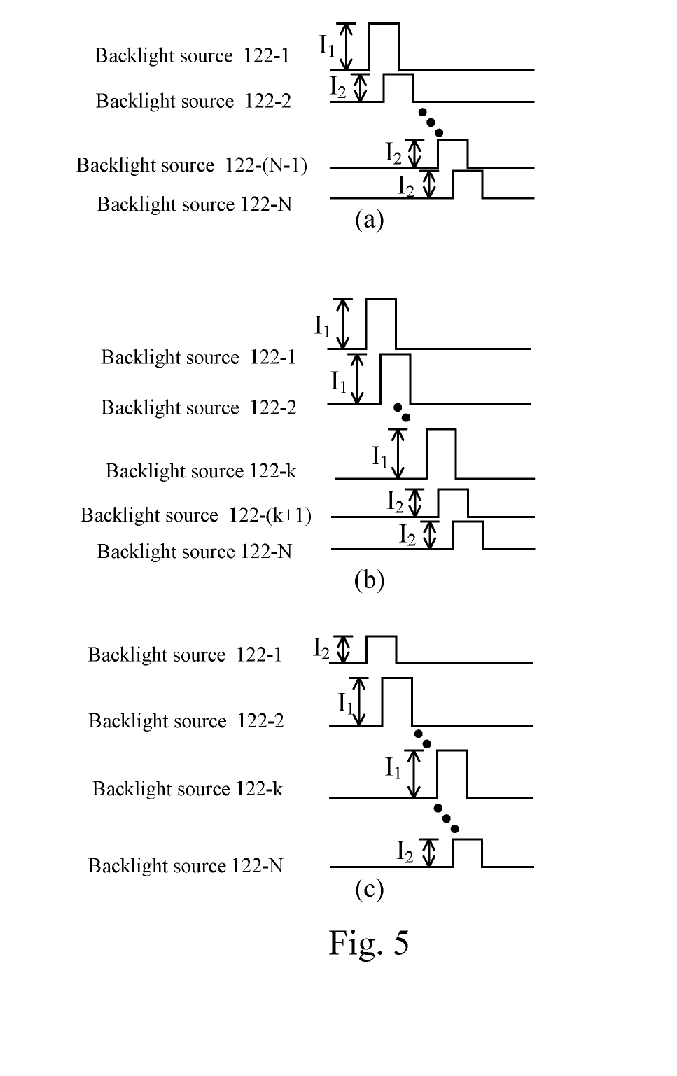

Please refer to FIG. 5, a timing diagram of driving current signals from the backlight driver 110 according to the first embodiment of the present invention. During the conversion from the first frame image to the second frame image in the liquid crystal panel 130, it takes a while for liquid crystal molecules in the liquid crystal display zones 130-1˜130-M to deflect to the required angle. While liquid crystal molecules are deflecting, some lights from the backlight sources 122-1˜122N would be obstructed, causing uneven luminance of displayed images. To avoid uneven luminance, after the first frame image is displayed in the liquid crystal panel 130 in the first time period, when the second frame images are being displayed in the liquid crystal panel 130 in the second time period and the shutter glasses 200 turns on, luminance of the backlight sources 122-1˜122-k is greater than luminance of the backlight sources 122-(k−1)˜122-N by adjusting N driving current signals from the backlight driver 110, whereas N>k>1. For more details, as in FIG. 5(a), make magnitude I₁ of the first driving current signals applied on the backlight source 122-1 larger than magnitude I₂ of the 2^{nd}˜N^{th} driving current signals applied on the backlight sources 122-2˜122-N. Or, as in FIG. 5(b), make magnitude I₁ of the driving current signals applied on the backlight sources 122-1˜122k larger than magnitude I₂ on the (k+1)^{th}˜N^{th} driving current signals applied on the backlight sources 122-(k+1)˜122-N. Or, as in FIG. 5(c), make magnitude I₁ of the driving current signals applied on the specific backlight sources 122-2 and 122-k larger than magnitude I₂ of the driving current signals applied on the rest backlight sources.

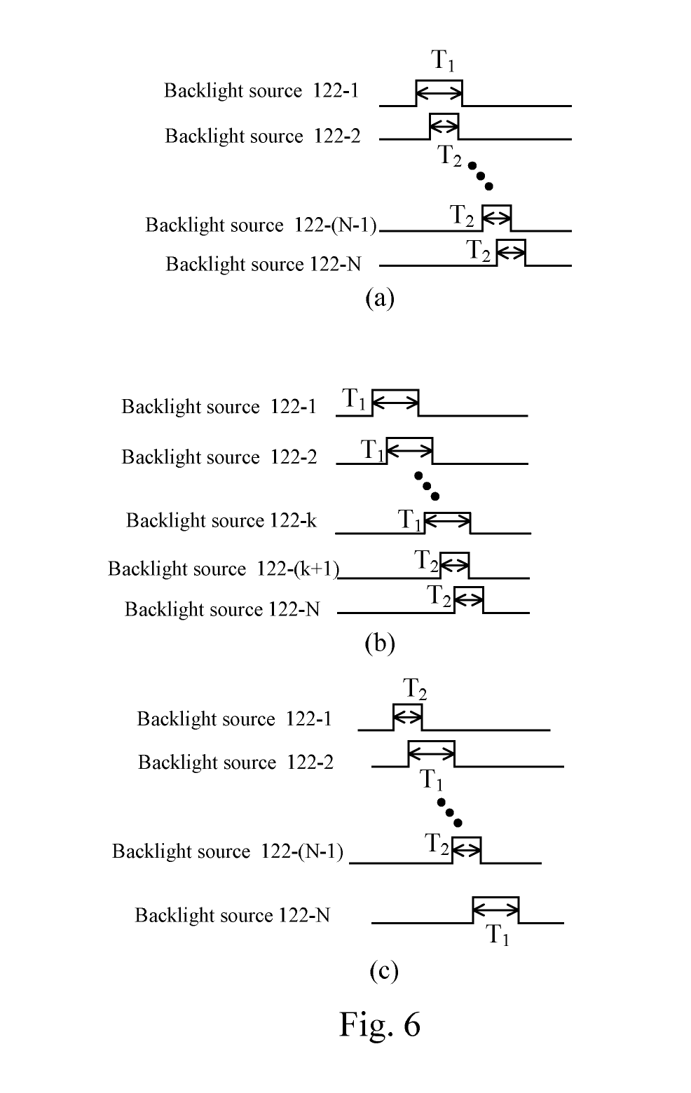

Please refer to FIG. 6, a timing diagram of driving currents signals from the backlight driver 110 according to the second embodiment of the present invention. To avoid uneven luminance, after the first frame image is displayed in the liquid crystal panel 130 in the first time period, when the second frame image is being displayed in the liquid crystal panel 130 in the second time period and the shutter glasses 200 turns on, luminance of the backlight sources 122-1˜122-k could be greater than luminance of the backlight sources 122-(k−1)˜122-N by adjusting N driving current signals from the backlight driver 110, whereas N>k>1. For more details, as in FIG. 6(a), make duty cycle T₁ of the first driving current signals applied on the backlight source 122-1 larger than duty cycle T₂ of the second˜Nth driving current signals applied on the backlight sources 122-2˜122-N. Or, as in FIG. 6(b), make duty cycle T₁ of the driving current signals applied on the backlight sources 122-1˜122k larger than duty cycle T₂ of the (k+1)^{th}˜N^{th} driving current signals applied on the backlight sources 122-(k+1)˜122-N. Or, as in FIG. 6(c), make duty cycle T₁ of the driving current signals applied on the specific backlight sources 122-2 and 122-N larger than duty cycle T₂ of the driving current signals applied on the rest backlight sources.

As magnitudes and duty cycles of driving current signals of every backlight source are different, image mura may happen due to different luminance of 3D images. In order to lessen image mura as possible, currents intensity and duty cycle of backlight sources have to be specially designed. Below is a formula for luminance of the i^{th} backlight source through the shutter glasses 200:

$$Luminance of the {i}^{th} backlight source = \frac{{\int }_{0}^{frame} Lum ( {I}_{i} , t ) \times Trans ( t ) \times d t}{frame} ,$$

where frame indicates displaying time of a frame (i.e. the first time period or the second time period), Lum(Iᵢ, t) indicates time-varying curve of luminous flux of a frame is being displayed when the i^{th} backlight source is under a current (equivalent to magnitude Iᵢ of driving current signals), Trans(t) indicates time-varying function of transmission of the shutter glasses 200 when a frame is being displayed,

Therefore, when magnitudes and duty cycles of driving current signals applied on every backlight sources are designed, the above formula must be taken into account, so that uniformity of luminance of the liquid crystal panel 130 as a whole satisfies a specific standard, such as uniformity of luminance≧85%, etc.

In sum, the 3D image display device and 3D image display system in the present invention enable every backlight source to generate lights of varying luminance according to driving current signals of varying magnitude and duty cycle, in order to raise display luminance of relatively dark zones of a liquid crystal panel, and eventually achieve an uniform luminance of the whole liquid crystal panel. More particularly, raising luminance of the liquid crystal panel when the shutter glasses are freshly turned on improves quality of 3D image display.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A 3D image display device, comprising:
a backlight source driver providing N driving current signals;
a backlight module, electrically connected to the backlight source driver, comprising N backlight sources which emit lights when receiving N driving current signals in sequence, wherein N is a positive integral greater than 1; and
a liquid crystal panel comprising a plurality of liquid crystal display zones to adjust alignment of liquid crystal molecules according to data signals;
wherein after the first frame image is displayed in the liquid crystal panel in the first time period, when the second frame image is being displayed in the liquid crystal panel in the second time period and the shutter glasses enables, luminance of 1^{st}˜k^{th} backlight sources is greater than luminance of (k+1)^{th}˜N^{th} backlight sources because the backlight source driver adjusts the N driving current signals, wherein N>k>1.

2. The 3D image display device of claim 1, wherein magnitude of the 1^{st}˜k^{th} driving current signals is greater than magnitude on the (k+1)^{th}˜N^{th} driving current signals.

3. The 3D image display device of claim 1, wherein a duty cycle of the 1^{st}˜k^{th} driving current signal is greater than a duty cycle of the (k+1)^{th}˜N^{th} driving current signal.

4. The 3D image display device of claim 1, wherein the second time period of subsequent to the first time period.

5. The 3D image display device of claim 1, wherein the first frame image is a left eye image and the second frame image is a right eye image, or the first frame image is a right eye image and the second frame image is a left eye image.

6. A 3D image display system, comprising:
a shutter glasses with an enabling time period;
a 3D image display device, comprising:
a backlight source driver providing N driving current signals;
a backlight module, electrically connected to the backlight source driver, comprising N backlight sources which emit lights when receiving N driving current signals in sequence, wherein N is a positive integral greater than 1; and
a liquid crystal panel comprising a plurality of liquid crystal display zones to adjust alignment of liquid crystal molecules according to data signals;
wherein after the first frame image is displayed in the liquid crystal panel in the first time period, when the second frame image is being displayed in the liquid crystal panel in the second time period and the shutter glasses enables, luminance of 1^{st}˜k^{th} backlight sources is greater than luminance of (k+1)^{th}˜N^{th} backlight sources because the backlight source driver adjusts the N driving current signals, wherein N>k>1.

7. The 3D image display system of claim 6, wherein magnitude of the 1^{st}˜k^{th} driving current signals is greater than magnitude on the (k+1)^{th}˜N^{th} driving current signals.

8. The 3D image display system of claim 6, wherein a duty cycle of the 1^{st}˜k^{th} driving current signal is greater than a duty cycle of the (k+1)^{th}˜N^{th} driving current signal.

9. The 3D image display system of claim 6, wherein the first frame image is a left eye image and the second frame image is a right eye image, or the first frame image is a right eye image and the second frame image is a left eye image.

10. The 3D image display system of claim 6, wherein the enabling time period is longer than the first time period and the second time period.
